(19) United States
(12) Patent Application Publication
(10) Pub. No.: US 2005/0268787 A1
(43) Pub. Date: Dec. 8, 2005

(54) Dust scrubber

(76) Inventor: Leslie Vincent Peddle Johnson, Brisbane (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/527,719

(22) PCT Filed: May 22, 2003
(86) PCT No.: PCT/AU03/00624

§ 371 Date: Mar. 14, 2005

(30) Foreign Application Priority Data
Sep. 13, 2002 (AU) 2002951368

(51) Int. Cl. B01D 47/00

(52) U.S. Cl. 96/297; 96/361

(57) ABSTRACT

A wet and a wet and dry dust removal apparatus, the latter for drilling applications including a housing, adapted to contain powered air induction means to induct air contaminated with particulate matter, water spraying means adapted to spray a mist of water into the induced air stream to capture the particulate matter, water removal means adapted to remove water droplets containing the particulate matter, the water removal means positioned in the housing parallel angle to the direction of the air flow, wherein the paralleled position by presenting a minimal drag profile in the air flow reduces the air pressure and velocity required to remove dust for a given volume of air, so that the energy consumption of the air induction means is correspondingly reduced.

### FIELD OF THE INVENTION

This invention relates to air filtration apparatus, in particular but not exclusively, to an improved low maintenance wet mineral dust remover adapted to operate with reduced noise and reduced energy consumption but having high dust removal efficiency.

### BACKGROUND OF THE INVENTION

Equipment designed for use in maintaining air quality in high dust environments are known. In particular, the problems associated with inhalation of mineral dust in mining operations contribute, for example, to certain medical conditions such as asbestosis, silicosis, industrial asthma and mesothelioma. The contraction of such debilitating diseases is an occupational hazard for workers or miners in the mineral refining industries and the cost to the community is very high in insurance premiums and payouts. Prior art air filtration devices include wet scrubbers which remove mineral dust particulate matter by passing air through a curtain of mist wherein the dust particles are trapped by water droplets. Such equipment requires high energy to operate as contaminated air is inducted at high velocity and pressure into the scrubbing vessel wherein it is passed through a fine mist of water. The water is then removed downstream by means of a mist eliminator contained in a suitable housing. Due to the high velocities and air pressures involved, not all droplets are eliminated by the mist eliminators and there are usually vane eliminators downstream of the mist eliminators to provide a further catchment system to remove residual water droplets. As there is high resistance to air flow, movement of the air through the prior art scrubbers require large motor driven fans that correspondingly consume large amounts of energy in the form of electricity or diesel fuel. There is also the problem of high noise generation levels with the use of large fans and motors.

### OBJECT OF THE INVENTION

It is an object of the present invention to seek to ameliorate some of the disadvantages and limitations of the prior art dust removal systems or to at least provide the public with an alternative and useful choice.

### SUMMARY OF THE INVENTION

Accordingly in one aspect, the invention resides in an improved wet dust removal apparatus including in combination
a housing having an inlet and an outlet, the housing adapted to contain
powered air induction means adapted to induce air contaminated with particulate matter into the inlet,
water spraying means adapted to spray a mist of water into the induced air stream to capture the particulate matter,
water removal means downstream of said water spraying means adapted to remove water droplets containing the particulate matter prior to the air exiting the housing via the outlet,
the water removal means positioned in the housing parallel to the direction of the air flow thereby potentially allowing for increasing the surface area of the water removal means along a length of the housing as opposed to a position oblique to the air flow wherein the size of the water removal means is limited to a cross sectional dimension or area of the housing, wherein
the parallel position, by presenting a minimal drag profile in the air flow, and the increased surface area reduces the air pressure and velocity required to remove dust for a given volume of air, and wherein in use, the energy consumption of the air induction means is thereby also reduced.

In a second aspect, the invention resides in a wet and dry dust removal apparatus for drilling applications including in combination
a housing having an inlet and an outlet, the housing adapted to contain
powered air induction means adapted to induce air contaminated with large and small drilling particulate material from the vicinity of a drilling operation into the inlet via a suction passage connected to the inlet,
cyclonic vacuum means adapted to remove by vacuum, the large and small particulate material,
water spraying means adapted to spray a mist of water into air exiting from the vacuum means to capture any fine dust particles escaping the vacuum means,
water removal means downstream of said water spraying means adapted to remove water droplets containing the dust prior to the cleaned air exiting the housing via the outlet,
the water removal means positioned in the housing parallel to the direction of air flow thereby potentially allowing for increasing the surface area of the water removal means along a length of the housing as opposed to a position oblique to the air flow wherein the size of the water removal means is limited by a cross sectional dimension or area of the housing wherein the parallel position by presenting a minimal drag profile to the air flow, and increased surface area reduces the air pressure and velocity required to remove dust for a given volume of air and, wherein in use, the energy consumption of the cyclonic vacuum means is thereby also reduced.

Furthermore, the parallel position of the water removal means or demister allows the air to stabilise and homogenise which reduces the load on the demister by eliminating surges in air flow and constituents, namely dust and water particles. This in addition, eliminates the requirement of additional means downstream of the demister, such as vanes or similar devices which are required for augmenting the removal of the water droplets during overload conditions or continuous heavy duty operation.

Preferably, the housing comprises a rectangular or cylindrical vessel having the inlet and outlet at either end.

Preferably, the vessel is fabricated from sheet steel which is welded. In the alternative, the vessel can be of fiberglass or aluminum construction.

Preferably, there are directional vane members for directing the air flowing out through the outlet in a preferred direction.

Preferably, the powered air induction means comprises an electric or hydraulic drive mechanism powering a fan,

Preferably, the fan is a multi-bladed fan with a blade diameter of up to one metre.

Preferably, the water spraying means comprises a plurality of water spray nozzles adapted to spray water droplets in the order of 100 microns in size.

Preferably, the nozzles are connected to a manifold into which water is injected under pressure.

Preferably, the water removal means comprises a mist eliminator fabricated from stainless steel or plastic filaments of various diameters and compositions.

Preferably, the individual filaments are between 0.05 mm to 2.5 mm in diameter.

More preferably, the filaments are approximately between 0.25 mm and 0.50 mm in diameter.

Preferably, the angle at which the water removal means is positioned in relation to the air flow is to optimize water removal.

Preferably, the cyclonic vacuum means comprises a cyclone type vessel which removes particles larger than 1.00 mm in size by centrifugal action and wherein smaller particles which do not conform to the physical forces are captured by the water spraying means.

Preferably, the suction passage comprises a shroud surrounding the drill adapted to contain solid particles and dust, the shroud connected by a flexible corrugated hose to the inlet.

Preferably, the cyclonic vacuum means is electrically driven. Alternatively, the cyclonic vacuum means can be driven by an internal combustion engine, typically a small diesel engine.

### BRIEF DESCRIPTION OF THE DRAWINGS

In order that the present invention be more readily understood and put into practical effect, reference will now be made to the accompanying illustrations wherein:

FIGS. 1a and 1b are preferred embodiments of the invention according to Example 1,

FIG. 1c an embodiment of the invention wherein the demister is in a prior art position,

FIG. 1d is a further embodiment of the invention of Example 1,

FIG. 2 shows an existing dust scrubber typical of the prior art, and

FIG. 3 shows a preferred embodiment of the second aspect of the invention according to Example 2,

### DETAILED DESCRIPTION OF THE DRAWINGS

### Example 1

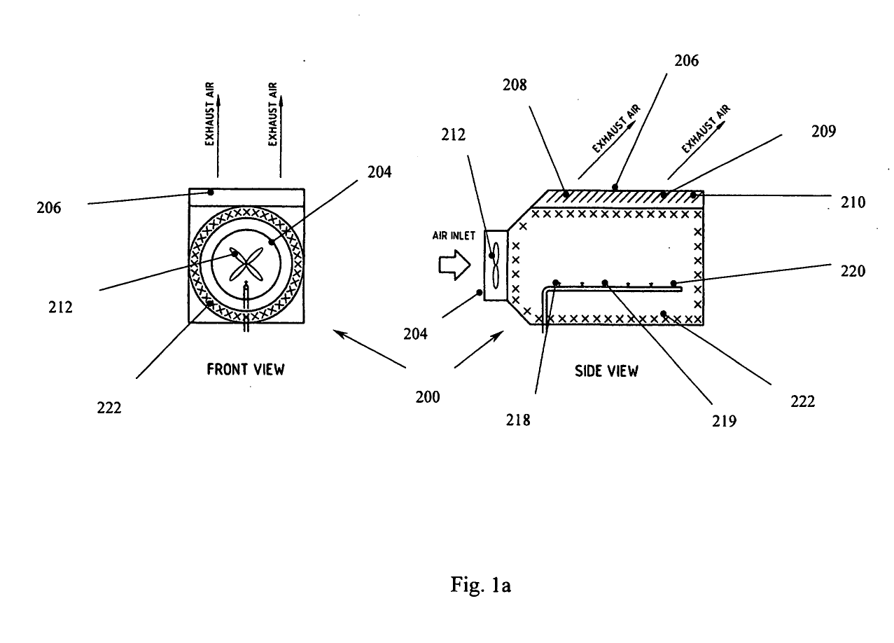

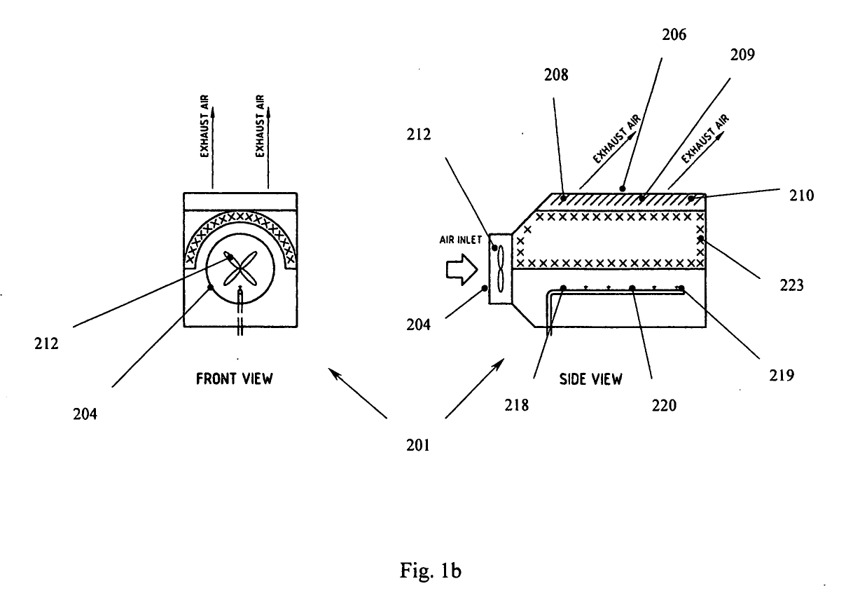

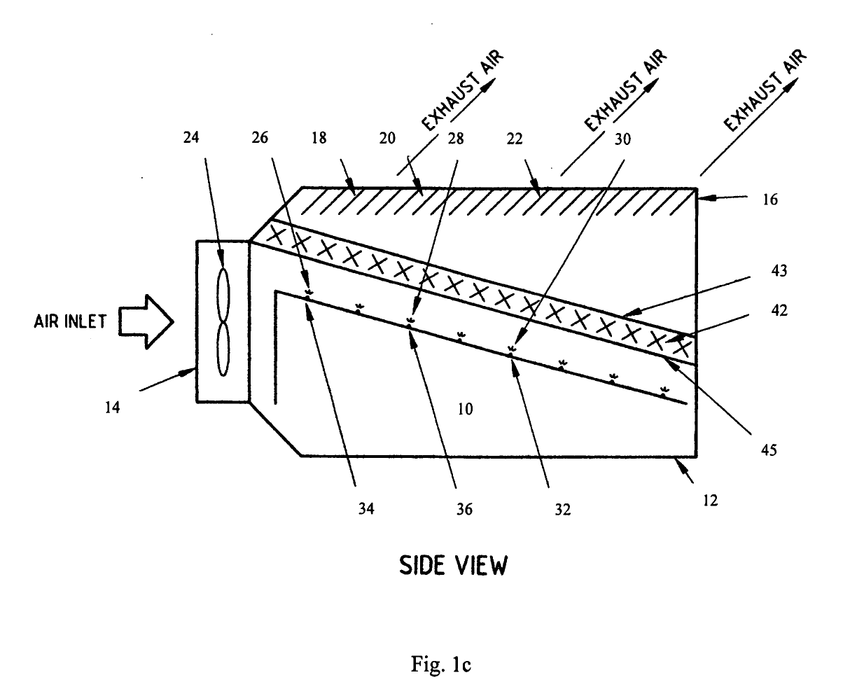

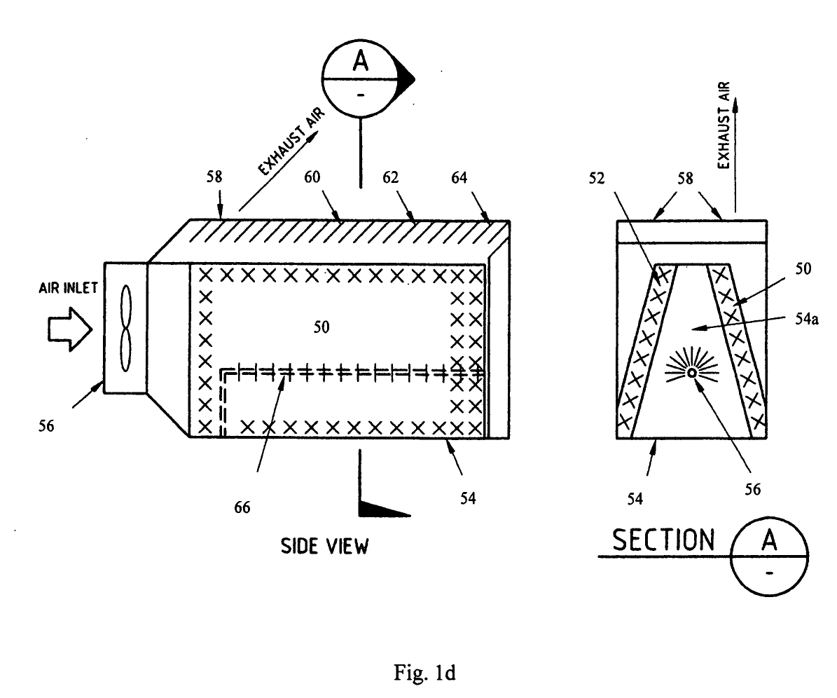

FIGS. 1a and 1b show preferred embodiments of the invention according to Example 1. The wet dust removal apparatus 200, shown in front and side views, 201 respectively comprises a rectangular housing of stainless steel. The housing has an inlet 204 and an outlet 206 wherein the outlet preferably has directional vane members 208-210 to direct the outflow of clean air in a preferred direction. The inlet houses a multi bladed fan 212 and comprises the air induction means which is powered preferably by an electrical hydraulic motor. The use of hydraulic motors is preferred in mining applications, as there is a danger of arcing or sparking with electric motors. Air containing dust particles are induced by the fan to flow into the housing via the inlet. Water mist is then sprayed into the air stream by a plurality of nozzles 218, 219, 220 comprising the water spraying means. Droplets of water capturing the dust particles are removed by the mist eliminator 222, 223. The mist eliminator comprises the water removal means and is preferably a filamentous composition of stainless steel and plastic filaments contain the frame or box between two panels of stainless steel mesh. The stainless steel plastic filaments 224 are preferably between 0.5 mm to 2.5 mm in diameter but more preferably have a diameter of between 0.25 mm and 0.5 mm. As is shown the mist eliminator 222 is circular in configuration in FIG. 1a and semi-circular 223 in FIG. 1b and is disposed parallel to the air flow to increase the surface area for water droplet removal and also to reduce the velocity in air pressure required to remove the same amount of water droplets when compared to a prior art mist eliminator positioned substantially perpendicularly to the air flow this results in less fan speed required and the need for energy expended in terms of large electrical or hydraulic motors. This contributes in a significant reduction to the energy consumption of the motor and a small fan can also be used.

Referring to FIG. 1c there is shown another embodiment of the invention wherein the mist eliminator 40 is positioned oblique to the air flow as is typical of the prior art. The wet dust removal apparatus 10 preferably comprises a cylindrical or rectangular housing 12 or vessel fabricated of welded stainless sheet steel. In the alternative, the housing can be constructed of fibreglass or aluminum.

The housing has an inlet 14 and an outlet 16 wherein the outlet preferably has directional vane members 18, 20, 22 to direct the outflow of clean air in a preferred direction. The inlet houses a fan 24 comprising the air induction means which is powered preferably by an electric or hydraulic motor. The use of hydraulic motors is preferred in mining applications as there is a danger of arcing or sparking with electric motors. Air containing dust particles are induced by the fan to flow into the housing via the inlet. Water mist 26, 28, 30 is then sprayed into the air stream by a plurality of nozzles 32, 34, 36 comprising the water spraying means. Droplets of water capturing the dust particles are removed by the mist eliminator 40. The mist eliminator that comprises the water removal means, is preferably a filamentous composition of stainless steel or plastic filaments 42 contained in a frame or box or between two panels 43, 45 of stainless steel mesh. The stainless steel or plastic filaments are preferably between 0.05 mm to 2.5 mm in diameter but more preferably have a diameter of between 0.25 mm and 0.50 mm. As is shown, the mist eliminator is disposed at an angle to the air flow to increase its surface area for water droplet removal. The increased surface area reduces the velocity and air pressure required to remove the same amount of water droplets as for a mist eliminator positioned substantially perpendicularly or at 90° to the air flow. This results in less fan speed required and the need for large electrical or hydraulic motors. This contributes in a reduction to the energy consumption of the motor and a smaller fan can also be used.

FIG. 1d shows another embodiment of the invention of Example 1. In this version, there are a pair of mist eliminators 50, 52 of the same design as that described for FIG. 1. The mist eliminators are positioned in an A-frame configuration in the housing 54 as shown in the sectional transverse view A-A. Air contaminated with dust is inducted via the inlet 56 into the chamber 54a formed by the mist eliminators. Water mist is sprayed from a longitudinal spray header 66 into the air stream. Dust particles are trapped by the water droplets which are removed by the mist eliminators. Cleaned air then exits the housing via the outlet region 58, the direction of the flow of air being guided by the directional vanes 60, 62, 64.

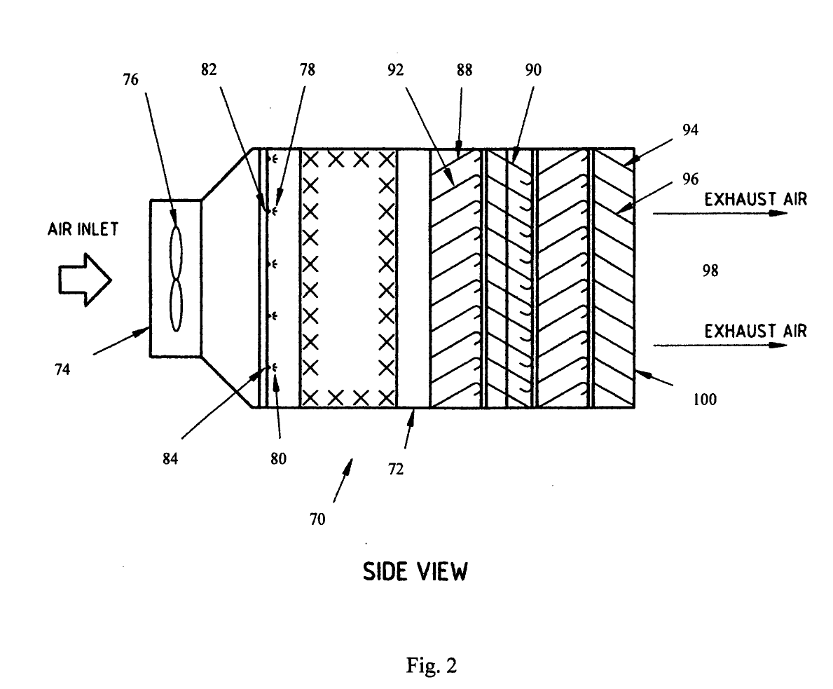

FIG. 2 shows a prior art dust scrubber 70 of an existing design. The housing 72 comprises an inlet portion 74 that houses a fan 76. Air carrying dust particles enters the inlet and is sprayed with water 78, 80 from spray nozzles 82, 84. Water droplets capturing the dust particles then pass through a filamentous mist eliminator 86 positioned at right angles to the air stream which presents a relatively reduced surface area for trapping water droplets. Furthermore, this also results in an increased back pressure requiring increased fan speeds or a fan with a larger blade diameter to move a given volume of air, as that compared to the present invention. As not all the water droplets are removed by the mist eliminator, there are also vane eliminators 88, 90, 92 downstream of the mist eliminator to remove the remaining droplets. It is evident that due to the improved efficiency of the present invention, vane eliminators are not required and are therefore absent. The prior art design also includes directional vanes 94, 96, 98 to direct the air flowing out of the outlet region 100.

### Example 2

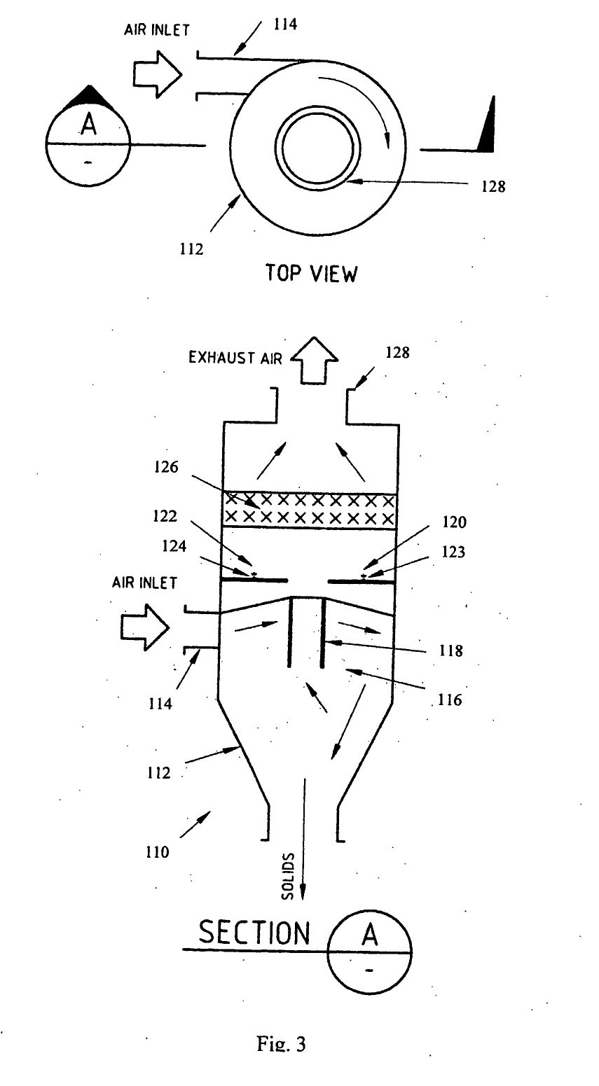

FIG. 3 shows a preferred embodiment of the second aspect of the invention according to Example 2. In this example, the wet and dry dust removal apparatus is especially adapted for use with drilling applications. The apparatus 110 is shown having a cylindrical housing 112 with an inlet 114 into which air containing large and small particulate material from around a drill from powered air induction means similar to that described in Example 1 is introduced. The cyclonic vacuum means 116 preferably comprises an electric motor driven cyclone type vessel 118 which is adapted to remove particles larger than 1.0 mm in size by centrifugal action. Smaller particles that do not conform to the physical forces required for removal by the centrifugal action pass from the cyclone type vessel into a mist 120, 122 produced by the nozzles 123, 124 of the water spraying means. The smaller particles of dust are caught by the water droplets which are then trapped by the mist eliminator 126 of a similar construction as is described in Example 1. It will be evident that although the mist eliminator is positioned perpendicularly to the longitudinal axis of the apparatus, that the air stream leaving the cyclone vessel strikes the mist eliminator at an oblique angle. Clean air substantially devoid of moisture then leaves via the outlet 128.

### ADVANTAGES

The advantages of the present invention include improved efficiencies in dust removal wherein the new design removes between 99.0% to 100% of respirable dust as compared to the existing design which removes between 94.0% to 95.0% of respirable dust. In terms of total dust removal, the present invention removes between 99.0% to 100% of the total dust content as compared to 98.0% to 99.0% of the total dust removed by prior art dust scrubbers. Furthermore, the present invention provides a power consumption saving in the order of 30% to 50% and noise levels are reduced over prior art dust scrubbers in the order of a 10% to 15% reduction.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1. A wet dust removal apparatus including in combination
a housing having an inlet and an outlet, the housing adapted to contain powered air induction means adapted to induce air contaminated with particulate matter into the inlet,
water spraying means adapted to spray a mist of water into the induced air stream to capture the particulate matter,
water removal means downstream of said water spraying means adapted to remove water droplets containing the particulate matter prior to the air exiting the housing via the outlet,
the water removal means positioned in the housing parallel to the direction of the air flow, wherein
the parallel position, by presenting a minimal drag profile in the air flow reduces the air pressure and velocity required to remove dust for a given volume of air, and wherein in use, the energy consumption of the air induction means is thereby also reduced.

2. A wet and dry duct removal apparatus for drilling applications including in combination
a housing having an inlet and an outlet, the housing adapted to contain powered air induction means adapted to induce air contaminated with large and small drilling particulate material from the vicinity of a drilling operation into the inlet via a suction passage connected to the inlet,
cyclonic vacuum means adapted to remove by vacuum, the large and small particulate material,
water spraying means adapted to spray a mist of water into air exiting from the vacuum means to capture any fine dust particles escaping the vacuum means,
water removal means downstream of said water spraying means adapted to remove water droplets containing the dust prior to the cleaned air exiting the housing via the outlet,
the removal means positioned in the housing parallel to the direction of air flow wherein the parallel position, by presenting a minimal drag profile in the air flow reduces the air pressure and velocity required to remove dust for a given volume of air and, wherein in use, the energy consumption of the cyclonic vacuum means is thereby also reduced.

3. A wet dust removal apparatus as claimed in claim 1 wherein the housing comprises a cylindrical vessel having the inlet and outlet at either end.

4. A wet dust removal apparatus as claimed in claim 1 wherein the vessel is fabricated from sheet steel which is welded or is of fiberglass or aluminum construction.

5. A wet dust removal apparatus as claimed in claim 1 wherein there are directional vane members for directing the air flowing out through the outlet in a preferred direction.

6. A wet dust removal apparatus as claimed in claim 1 wherein the powered air induction means comprises an electric or hydraulic drive mechanism powering a fan.

7. A wet dust removal apparatus as claimed in claim 6 wherein the fan is a multi-bladed fan.

8. A wet dust removal apparatus as claimed in claim 1 wherein the water spraying means comprises a plurality of water spray nozzles adapted to spray water droplets in the order of 100 microns in size.

9. A wet dust removal apparatus as claimed in claim 8 wherein the nozzles are connected to a manifold into which water is injected under pressure.

10. A wet dust removal apparatus as claimed in claim 1 wherein the water removal means comprises a mist eliminator fabricated from stainless steel or plastic filaments of various diameters and compositions.

11. A wet dust removal apparatus as claimed in claim 10 wherein the individual filaments are between 0.05 mm to 2.5 mm in diameter.

12. A wet dust removal apparatus as claimed in claim 10 wherein the filaments are between 0.25 mm and 0.50 mm in diameter.

13. A wet and dry dust removal apparatus as claimed in claim 2 wherein the cyclonic vacuum means comprises a cyclone type vessel which removes particles larger than 1.00 mm in size by centrifugal action and wherein smaller particles which do not conform to the physical forces are captured by the water spraying means.

14. A wet and dry dust removal apparatus as claimed in claim 2 wherein the suction passage comprises a shroud surrounding the drill adapted to contain solid particles and dust, the shroud connected by a flexible corrugated hose to the inlet.

15. A wet and dry dust removal apparatus as claimed in claim 2 wherein the cyclonic vacuum means is electrically driven or is driven by an internal combustion engine, typically a small diesel engine.

16-17. (canceled)

18. A wet dust removal apparatus as claimed in claim 2 wherein the housing comprises a cylindrical vessel having the inlet and outlet at either end.

19. A wet dust removal apparatus as claimed in claim 2 wherein the vessel is fabricated from sheet steel which is welded or is of fiberglass or aluminum construction.

20. A wet dust removal apparatus as claimed in claim 2 wherein there are directional vane members for directing the air flowing out through the outlet in a preferred direction.

21. A wet dust removal apparatus as claimed in claim 2 wherein the powered air induction means comprises an electric or hydraulic drive mechanism powering a fan.

22. A wet dust removal apparatus as claimed in claim 2 wherein the water spraying means comprises a plurality of water spray nozzles adapted to spray water droplets in the order of 100 microns in size.

23. A wet dust removal apparatus as claimed in claim 2 wherein the water removal means comprises a mist eliminator fabricated from stainless steel or plastic filaments of various diameters and compositions.
